(19) United States
(12) Patent Application Publication
(10) Pub. No.: US 2016/0302388 A1
(43) Pub. Date: Oct. 20, 2016

(54) CAT SCRATCHER ATTRACTANT DEVICE

(71) Applicant: Worldwise, Inc., San Rafael, CA (US)

(72) Inventors: Charles Floyd, Oakland, CA (US); Michael Risso, Napa, CA (US); Aimee Diskin, Napa, CA (US); Hannah Rosenberg, San Francisco, CA (US)

(21) Appl. No.: 14/686,213

(22) Filed: Apr. 14, 2015

(51) Int. Cl. A01K 15/02

(52) U.S. Cl. CPC A01K 15/025; A01K 15/024

(57) ABSTRACT

A cat scratcher attractant device having a vertically extending axis, a housing having a hollow interior and exterior and a cap terminating an end of the housing, the cat scratcher attractant device further including, a motor and microprocessor supported by and enclosed within the housing. The motor has a rotatable shaft positioned along the vertically extending axis. A wand and an attractant are provided, the wand having first and second ends, the first end being fixed to the rotatable shaft and the second end being fixed to the attractant. The microprocessor is program to control operation of the motor to cause the want to rotate intermittently, the exterior surface of the housing being a cat scratching surface.

### TECHNICAL FIELD

The present invention involves a cat scratcher based attractant and amusement device capable of encouraging a domestic cat to employ a dedicated scratching surface rather than scratching furniture, carpets and drapes and to maintain a cat's interest for prolonged periods of time in doing so.

### BACKGROUND OF THE INVENTION

It is well recognized that domestic cats crave scratching as part of their natural instinctive character. If a dedicated scratching surface is not provided, domestic cats would generally satisfy their need to scratch by turning to furniture, curtains and other articles which can be substantially damaged as a consequence. Often times, pet cats will not only climb over furniture, specifically upholstered chairs and sofas, but will use such furniture and carpeting to condition their claws through deliberate repeated clawing, pulling and tearing actions specifically with their forepaws. As noted, this clawing activity appears to be an irresistible natural impulse for cats and can be the source of great aggravation to the pet owner.

There are a number of vendors of pet and pet related products that have offered implements dedicated to alleviating the need of a cat to scratch. These include cat scratching posts and pads comprised of, for example, carpet, sisal, seagrass, rope and cardboard. In most instances, the cat scratching surface is simply made available to the cat relying upon the cat to seek it out on its own. To encourage cats to use a dedicated scratching surface, often times, a pet product manufacturer will infuse catnip or similar attractant into the body of the scratching surface. However being merely a passive post or pad, cats will often times get bored and engage in destructive activity which could have been avoided if an attempt was made to actively attract a cat to the scratching surface and to keep it engaged with the scratcher by playing upon a cat's natural curiosity to seek out and swat objects as it would prey.

In addition to a cat's need to scratch, domestic cats also require stimulation. Without it, they get bored which could result in health problems and associated unwelcome anti-social behavior. It is also well known to anyone owning a pet cat that they possess a natural instinct to swat, pounce and attack dangling or moving attractants and can almost be mesmerized by them for long periods of time.

It is been well recognized that there is a need for a toy which could move an attractant, such as a feathered bundle, to provide stimulation. For example, such a device is disclosed in U.S. Pat. No. 6,892,675 causing an attractant to rotate at a fixed constant speed. However, because of its constant nature, the device made the subject of the '675 patent is unable to maintain a cat's interest for prolonged periods.

It is thus an object of the present invention to provide a cat attractant device which will maintain a cat's interest for a prolonged period in the vicinity of a scratcher encouraging prolonged use of the scratcher to the exclusion of furniture, drapes and other household objects which would be damaged if the pet was to use them to satisfy its need to scratch.

These and further objects will be readily apparent when considering the following disclosure and appended claims.

### SUMMARY OF THE INVENTION

A cat scratcher attractant device comprising a vertically extending axis, a housing having a hollow interior and exterior and a cap terminating an end of said housing, said cat scratcher attractant device further comprising a motor and microprocessor supported by and enclosed within said housing, said motor having a rotatable shaft positioned along said vertically extending axis, a wand and an attractant, said wand having first and second ends, said first end being fixed to said rotatable shaft and said second end being fixed to said attractant, said microprocessor being programmed to control operation of said motor to cause said wand to rotate intermittently, said cat scratcher attractant device further being characterized as having a cat scratching surface on the exterior of said housing.

### BRIEF DESCRIPTION OF THE FIGURES

FIG. 1 is a perspective view of the cat scratcher attractant device of the present invention.

FIG. 2 is a side view of the cat scratcher attractant device as shown in FIG. 1.

FIG. 3 is a partial cross-sectional view of the cat scratcher attractant device of FIG. 1 illustrating its internal components.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

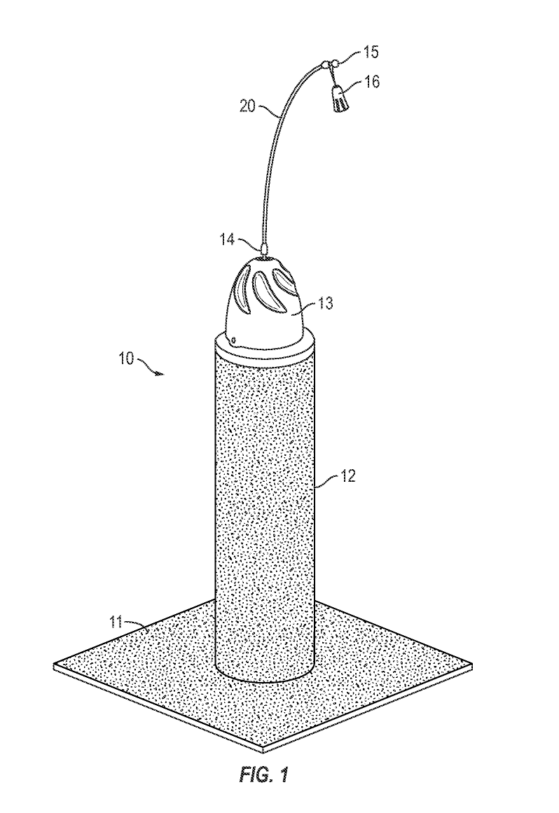

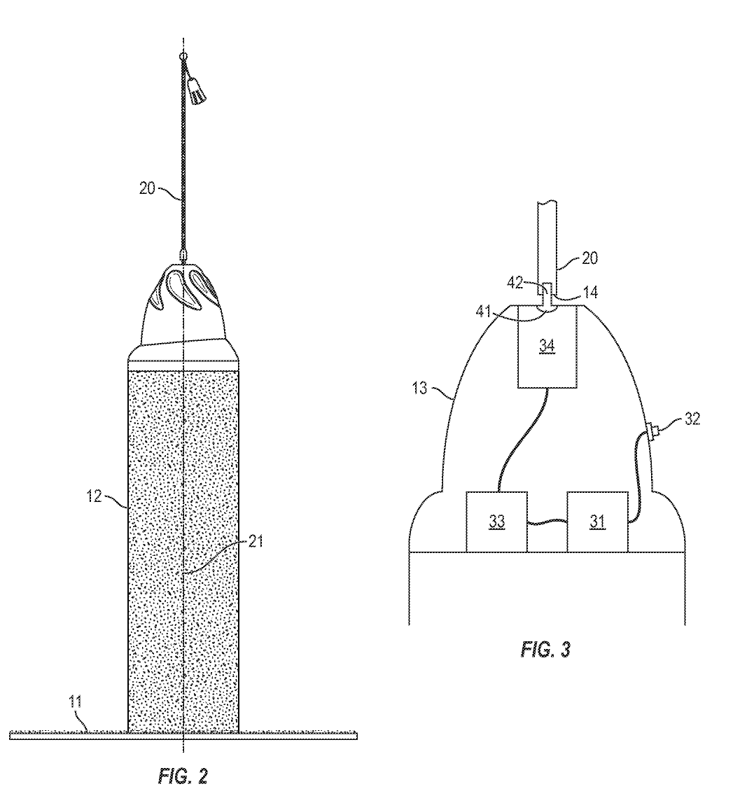

Turning first to FIGS. 1 and 2, cat scratcher attractant device 10 is illustrated having vertically extending axis 21 centered within housing 12. Housing 12 is generally provided with a hollow interior oriented perpendicularly to horizontally extending platform 11. On the opposite side of platform 11 is cap 13 which can be removed from housing 12. As a preferred embodiment, housing 12 is substantially cylindrical having its cylindrical axis extending vertically along said vertically extending axis 21. The exterior of housing 12 is provided with a scratcher surface such as carpet, sisal or rope and as a further preferred embodiment, horizontally extending platform 11 can also support a scratcher surface.

Cap 13 is configured with opening 41 through which motor shaft 42 extents. Motor shaft 42 is driven by motor 34, which, in turn, is driven by power supply 31, ideally in the form of a battery pack, having an externally accessible on/off switch 32 although power supply 31 could be eliminated by using an external AC adapter to enable cat scratcher attractant device 10 is driven by household AC current.

Power supply 31 (or external power supply, not shown) is connected to microprocessor 33 also contained within housing 12 or cap 13 and is programed to control the operation of motor 34 as will be more fully discussed below.

Motor 34 is provided with motor shaft 42 which spins along the longitudinal axis 21 to rotate wand 20 which is provided with first end 14 and second end 15, first end 14 being connected to motor shaft 42 such that when motor 34 is activated, wand 20 spins over platform 11 as it preferably bows as shown.

Typical devices of this kind tend to employ a motor which is binary, that is, either on or off. When on, its motor shaft spins causing associated wand to spin. Because of the constant speed of rotation, the movement of attractant 16 can be predictable and as a consequence, causes a cat using it to become bored. By contrast, the present invention is provided with microprocessor 33, the microprocessor being programmed to control operation of motor 34 to cause wand 20 to rotate intermittently. Ideally, microprocessor 33 is provided with at least two programs for selectively controlling rotation of shaft 42. In doing so, rotation of shaft 42 is somewhat haphazard which, in conjunction with the weight of attractant 16 causes wand 20 to rotate haphazardly greatly enhancing its interest to an engaged cat.

In implementing the present invention, the designer of its physical implementation can benefit from a good deal of discretion in determining the extent of movement of attractant 16. Specifically, design parameters include the relative weight of attractant 16, the speed and intermittent activation of motor 34 as a result of its control by microprocessor 33 and the length and stiffness of wand 20.

In order to add to the life and flexibility the present invention, it is proposed that wand 20, at first end 14 be releasably connected to motor shaft 42. This can either be done by a simple fictional connection, screw connection or snap-fit connection. In doing so, as a cat engages the present toy, and as a result, degrades either attractant 16 or wand 20, a pet owner can simply replace these elements without having to replace the entire assembly, thus extending the life of the present toy also indefinitely. Also, as preferred embodiments, the pet owner could select from wands of different curvature and attractant 16 can be selectively removed from wand 20 at second and 15 to be replaced once degraded or to change them in order to vary cat attractant device 10 to stimulate the cat's ongoing interest.

In use, attractant 16 rotates above horizontal platform 11 which may be provided with a scratcher surface and also rotates proximate to the exterior surface of housing 12. As wand 20 spins about vertical axis 21, a cat's natural instinct to swat and pounce will result in the pet's attempt to get close to the attractant and, in doing so, will step onto horizontal platform 11 and in swiping at attractant 16, will engage the exterior surface of housing 12. These activities will satisfy the cats need to scratch is well as its need to pursue prey. This combination of parts synergistically maintains a cat's interest and satisfies these multiple needs far longer than would be the case when either a scratcher alone or a rotating attractant alone are offered to a domestic cat.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat scratcher attractant device comprising a vertically extending axis, a housing having a hollow interior and exterior and a cap terminating an end of said housing, said cat scratcher attractant device further comprising a motor and microprocessor supported by and enclosed within said housing or cap, said motor having a rotatable shaft positioned along said vertically extending axis, a wand and an attractant, said wand having first and second ends, said first end being fixed to said rotatable shaft and said second end being fixed to said attractant, said microprocessor being programmed to control operation of said motor to cause said wand to rotate intermittently, said cat scratcher attractant device further being characterized as having a cat scratching surface on the exterior of said housing.

2. The cat scratcher attractant device of claim 1 in which said housing is substantially cylindrical having a cylindrical axis of which extends along said vertically extending axis.

3. The cat scratcher attractant device of claim 2 in which said cylindrical housing is fixed to and supported by a substantially horizontally extending platform.

4. The cat scratcher attractant device of claim 3 wherein said horizontally extending platform is at least partially covered with a cat scratching surface.

5. The cat scratcher attractant device of claim 1 wherein said wand is selectively removable from said rotatable shaft.

6. The cat scratcher attractant device of claim 1 wherein said attractant is selectively removable from said wand.

7. The cat scratcher attractant device of claim 1 further comprising a power supply positioned within said housing.

8. The cat scratching attractant device of claim 1 wherein said microprocessor is provided with at least two programs for selectively controlling the rotation of said shaft.
